(19) United States
(12) Patent Application Publication
(10) Pub. No.: US 2005/0164687 A1
(43) Pub. Date: Jul. 28, 2005

(54) Implementation of controls by use of customer programmable portal

(75) Inventor: Robert A. DiFazio, Greenlawn, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/000,306

(22) Filed: Nov. 30, 2004

Related U.S. Application Data
(60) Provisional application No. 60/525,962, filed on Dec. 1, 2003.

(51) Int. Cl. H04M 3/00

(52) U.S. Cl. 455/418; 455/412.2

(57) ABSTRACT

A user interface is utilized to establish control communications through a wireless cellular network and a wireless transmit/receive unit (WTRU). The control information is then used to provide user function control and can be used to provide additional data to the user interface, such as location information regarding the WTRU.

### CROSS REFERENCE TO RELATED APPLICATION(S)

This application claims the benefit of U.S. provisional application No. 60/525,962, filed on Dec. 1, 2003, which is incorporated by reference as if fully set forth.

### FIELD OF INVENTION

The present invention relates to wireless network communications. More particularly, the present invention is directed to control of network connected devices by use of a terminal.

### BACKGROUND

Location information for wireless transmit/receive units (WTRUs) is available by use of various network protocols. In addition, geolocation devices such as a global positioning system (GPS) receiver are sometimes provided for WTRUs. Such information is available to the network or, in some cases, to the user of the WTRU. It is sometimes desired to control the use of a WTRU remotely and to provide a remote indication of location to another user.

It would be desirable if specific control and location capabilities for communicating with a particular WTRU were obtained by implementing above the air interface protocol stack, or with minimal information extracted from the protocol stack.

### SUMMARY

According to the present invention, a user control interface is provided at a user location separate from a WTRU. When a wireless network connection is established, control communication is provided between the WTRU and the user location through the wireless network connection. In one configuration, the control communication includes the geographical location of the WTRU. The geographical location of the WTRU is thereby remotely provided to the user control interface. In another configuration, the control communication includes user interface control. The user interface provides control of the WTRU remotely provided to the WTRU by remote execution of user control functions of the WTRU.

### BRIEF DESCRIPTION OF THE DRAWINGS

FIG. 1 is a diagram showing network connections between various components communicating with a user's device.

FIG. 2 is a block diagram of a WTRU which is responsive to external controls, constructed in accordance with the present invention.

FIG. 3 is a diagram of a “tag” used to provide tracking functions according to one aspect of the present invention.

FIG. 4 is a flow diagram depicting the operation of an exemplary embodiment of the invention.

### DETAILED DESCRIPTION OF THE PREFERRED EMBODIMENTS

The present invention is useful in wireless, such as cellular, wireless wide area metropolitan and wireless local area networks. Such systems use base stations (BS) and wireless transmit/receive units (WTRUs). A WTRU includes but is not limited to a user equipment, mobile station, fixed or mobile subscriber unit, pager, or any other type of device capable of operating in a wireless environment. A “base station” includes but is not limited to a Node B, site controller, access point or other interfacing device in a wireless environment.

The inventive features may be implemented as one or more applications on a terminal, where at least one end is a wireless terminal connected to a shared wireless network, such as a cellular telecommunications network. The terminal on the other end may be another WTRU, a PC with compatible application software, or a special purpose device. The terminal includes a user interface, although it is understood that some of the functions of the user interface can be on a physical device which is separate from the user interface. Although, some of the direct control functions would benefit from inclusion in network protocols, much of the required signaling could be executed with pre-existing short messaging protocols or other applications provided under the standard in use on the wireless network. Examples of the use of applications provided under the standard include SMS and IP applications enabled by GPRS or 3G protocols.

According to one aspect of the present invention, a WTRU provides communication of information dedicated to a predetermined WTRU. In one particular aspect of the invention, a WTRU is controlled remotely. The application on the WTRU at the remote site limits the user's access to the wireless network for the purpose of controlling the service cost, limiting liability if the terminal is lost, or limiting the services that can be selected. In this way, the WTRU can be remotely controlled as to its use. By way of example, the application software can implement the following:
a) Limit the calls to one phone number or a small list of phone numbers.
b) Limit the total number of minutes.
c) Limit the calls to a particular area code or other identifiable geographic area.
d) Allow the home terminal to send a message to the remote WTRU to disable it completely, or enable/disable/configure, any of the items listed above or any other functions.

In an illustrative case, an owner of a phone may wish to have a young child have access to a mobile telephone but not use the mobile telephone beyond limited parameters. This could be accomplished by address book restrictions, but the desire may be to allow more flexibility in the limited use than afforded by fixed controls. It may also be desired to change the restrictions, for example during travel. For example, the owner may wish to permit the mobile telephone to be used only for emergencies and for calling the owner at one location, but permit more use of the mobile telephone at another location or at a different time. Generally this can be accomplished by the user of the WTRU; however, there are circumstances in which direct control by the owner is advantageous. Likewise, the owner of the WTRU may wish to remotely lock a WTRU from unauthorized use, for example if the WTRU is misplaced.

Most WTRUs are able to be programmed for various functions. At a basic level, this includes assigning an identity to the WTRU and basic user interface functions. In addition, transmit/receive parameters and SIM data, preferred roaming list (PRL), or the equivalent are commonly provided through the network. Typically, these functions are provided by the network administrator. Control of most user functions is effected directly by the user on the WTRU or in some cases through a hardwire data connection to the WTRU.

A common feature of wireless communication networks is that they typically provide the WTRU with some knowledge of the base station it is connected to and nearby base stations. This information is typically signaled to WTRUs and located in the protocol stack as location area identities, network identities, base station identities, neighbor lists, broadcast channel parameters, and other network functions useful for identifying the WTRU location. In addition, measurements the WTRU performs to assist in handover, cell selection, or cell reselection can provide rough indications of proximity to base stations. If the WTRU has access to the protocol stack software, this information can be extracted, encapsulated into a message and sent to another terminal. The WTRU or the remote terminal is then able to perform the processing to roughly estimate position.

If the wireless network provides location services, such a location function is enhanced. However, it is also possible to perform these location functions based on data available to a user connected to the network. It is noted that it would be necessary to map the base station parameters into approximate geographic coordinates since they are not typically known to the WTRU. Those parameters change infrequently, so it can be done based on knowledge of the location of cell sites.

It is also possible to use a WTRU equipped with special application software to analyze the system for location data. This has the advantage of allowing the use of GPS or similar geolocation to be correlated with network-based information, so that a WTRU which is not receiving GPS data can be tracked with corresponding network-based information.

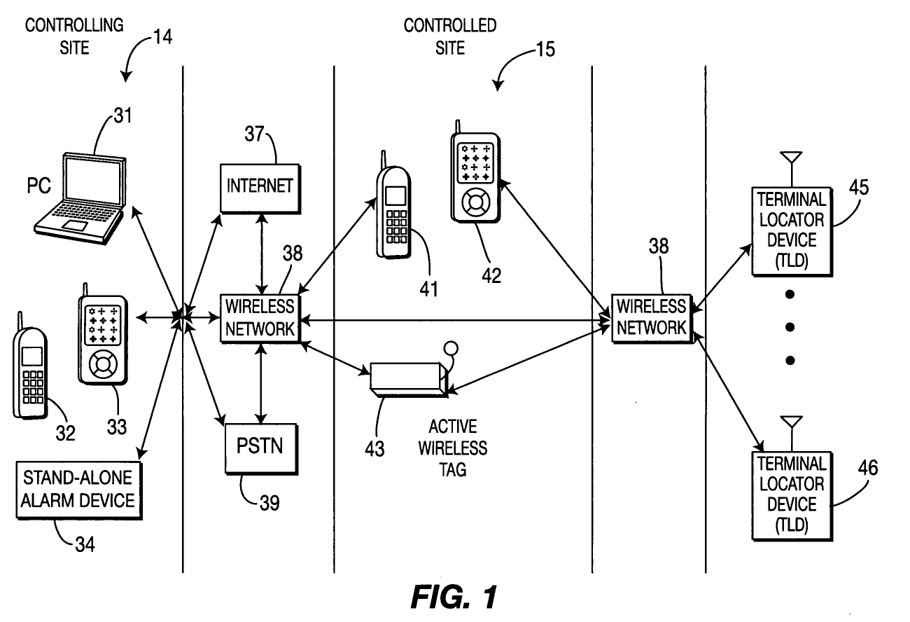

FIG. 1 is a diagram showing network connections between various components communicating with a user's device. Depicted are a “controlling” site 14 and a “controlled” or “responsive” site 15. Depending on the particular configuration, the degree of control exercised by the controlling site 14 on the controlled site may be limited.

At the controlling site 14 terminals 31-34 include a PC 31, mobile terminals 32-33 and a dedicated stand-alone alarm monitor device 34. These terminals communicate with wired or wireless connections to the Internet 37, wireless network 38, or PSTN 39. These are considered to be controlling units because they are used to transmit requests to control WTRUs 41-43 at the controlled site 15. While the controlling site devices are depicted at a single location, the connections of the controlling devices are such that the controlling devices can be located at any convenient place.

The controlled site 15 is generally directly operated by a user who is local to the device even though the responsive device is remotely controlled by the controlling site 14. The control affects the device locally. The controlled site 15 includes WTRUs 41-43 with wireless connections to the wireless network. These are the units which the invention keeps track of or which are restricted. It is noted that the controlled site 15 terminals 41-43 may be connected to a home network, such as Internet 37, wireless network 38 and PSTN 39 described above. It is also possible in some cases to use a terminal locator device 45, 46, also connected to wireless network 38. While the wireless network 38 is described monolithically, it is also possible to permit roaming of the responsive terminals 41-43, subject to the limitations of SMS or other employed communication protocol through diverse networks.

The responsive terminals 41-43 interact with the wireless network like any other subscriber. Two types of devices are shown:
1) typical WTRUs 41, 42; and
2) a special purpose “tag” WTRUs 43 which can have the sole or additional purpose of tracking someone or something.

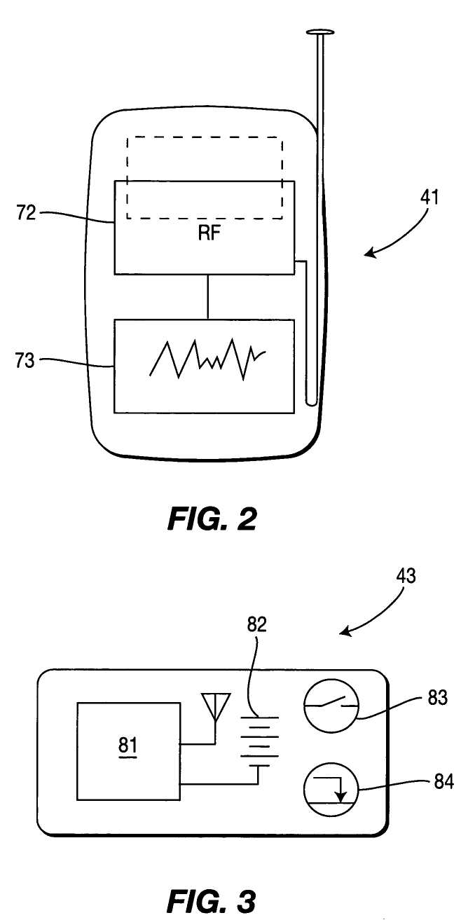

FIG. 2 is a diagram showing an exemplary configuration of a WTRU 41 used in the present invention. The WTRU 41 includes an RF section 72 and a signal processing section 73. The signal processing section 73 also functions to execute commands and control the RF section 72 so as to respond to requests to control the WTRU 41. These functions can be provided via discrete or semi-discrete components, or can be integrated into a monolithic or hybrid semiconductor integrated circuit (IC) chip. The use of an IC chip permits ease of manufacture, in that the functions are self-contained in the circuitry embodied in IC chip.

The “tag” WTRU 43 would have a wireless network identity like any other WTRU and interact in conformance with the air interface standard. While it would be economical if the operator of the network provides particular functions to be used by the inventive system, the system does not require such functions.

As shown in FIG. 3, the functions of the “tag” WTRU 43 can be provided by use of an integrated circuit (IC) chip 81 which integrates some or all of the functions of the “tag” WTRU 43. This permits convenient packaging of the “tag” WTRU 43 which may include a power supply 82 and other controls such as a power switch 83 and “ident” switch 84 for intentional broadcast identification. The “ident” switch can be used to provide specific identification, or can provide a “panic” switch function.

In operation, each time the controlled WTRU 41-43 registers or affiliates with a cell, the application, software extracts or is provided the base station parameters from the protocol stack. Each time the controlled WTRU 41-43 measures signal quality, relative time delay, or any parameters that indicates signal quality or distance from a cell, the application software extracts or is provided the base station parameter and measurements from the protocol stack. The controlled WTRU encapsulates the parameters and measurements into a message that is sent to a terminal at the home site. The message can be sent periodically or each time the WTRU affiliates with a new cell. A filtering algorithm can be used to infer when the WTRU's position has changed significantly. The filtering algorithm may use a combination of mathematical and logical operations to process the measurements and conclude when a significant change in position has occurred. For example, the filtering may be as simple as determining when the primary, reference or serving cell has changed. Alternatively, the filtering algorithm may form averages of signal quality or time delay measurements and set a threshold that, when crossed, indicates a significant change in position. A combination of the above may be used, for example combining averaged measurements with information about cells in the active set or neighbor list. The application software at the home site contains information that maps the parameters into geographic coordinates and implements the algorithms that estimate location. According to one embodiment of the invention, the controlled WTRU is configured to accept and respond to commands from another device, but the other device need not include special programming to transmit such commands. Of course, as is the case with command protocols in general, it is possible to provide programming to facilitate issuing commands from a terminal 31-34 at the controlling site 14.

Any of this processing can be done at the WTRU prior to the message being sent. However, to keep the applications at the WTRU as simple as possible, it may be preferable to implement the processing at the controlling site. This would enable the following types of applications:
i) The terminal at the home site can approximately track the movement of the remote WTRU.
ii) The terminal at the home site can provide an alarm if the remote WTRU moves out of a designated area.
iii) The terminal at the home site can provide an alarm if periodic messages are not received from the remote WTRU.
iv) The terminal at the home site can send messages to enable/disable/configure the parameters or processes on the WTRU.

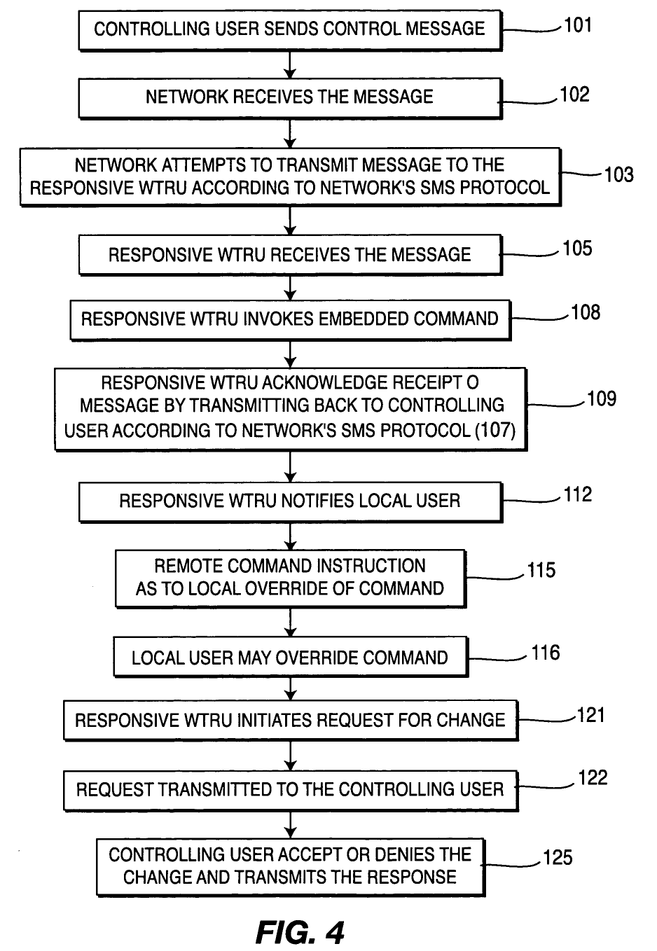

FIG. 4 is a flow diagram depicting the operation of an exemplary embodiment of the inventive control device, using a message system. The owner sends a control message as a controlling user (step 101), upon which the network receives the message (step 102). The network attempts to transmit the message to the responsive WTRU (step 103) according to the network's short message service (SMS) protocol or other message transmission technique.

The responsive WTRU, on receipt of the message, responds to a command embedded in the message by invoking the command (step 108). When the responsive WTRU receives the message it may return an acknowledgment to the controlling user according to the network's short message service (SMS) protocol or other message transmission technique 109. If the controlling user does not receive the acknowledgement, then it may assume the process has failed and may try again.

After the responsive WTRU invokes the command (step 108), the responsive WTRU notifies the local user of the responsive WTRU of a response to a remote procedure call (step 112). The remote command may include an instruction (step 115) as to whether local override of the command by the local user of the responsive WTRU (step 116) is permitted, presumably using a password for such local override. It is presumed that one of the control functions would be mandatory acceptance of messages of the type used to effect the control function, at least in circumstances where acceptance of additional control commands are desired.

The controlling user may also use the capabilities of the WTRU and the network to monitor the location or activity of the WTRU. In this case, the control consists of receiving location or activity signals through the network, either in response to individual requests to the WTRU or by querying the network. The monitoring can be per request or continuous.

It is possible to provide for external factors to control a change in restriction or other control of the WTRU, such as time or location. It is also possible for the controlling user to control the WTRU, for example upon receipt of a communication from the local user of the responsive WTRU informing the controlling user of a change in status. In the event of subsequent control by the controlling user, the procedure would be similar to that of the initial control (steps 101-116).

It is also possible for the local user of the responsive WTRU to initiate a request for change in operation (step 121), which can be accepted or denied by the controlling user. In such an arrangement, the local user of the responsive WTRU determines a change in restriction, for example no call restrictions and enters the change in restriction as a request. The request is transmitted (step 122) to the controlling user, upon which the controlling user may accept or deny the change and transmit the response (step 125). The command for the change can be retained by the WTRU or transmitted back to the WTRU; however if the command is retained by the WTRU, the response from the controlling user can be the simple “accept or deny” (step 125). The controlling user also has the option to deny the request and then initiate a subsequent change in restriction (e.g., a modification of the requested change in restriction).

As an alternative, after the network attempts to transmit the message to the responsive WTRU [0001] (step 103), either the responsive WTRU receives the message and acknowledges receipt or the message is received without acknowledgement. If the message is received without acknowledgement, the network may still acknowledge whether the responsive WTRU is in general communication with the network, with communication of the message presumed.

The ability to modify the operation of the WTRU can include overriding the command by the owner as a controlling user, or by the local user of the responsive WTRU presumably by use of a password. The password control of changes by the local user of the responsive WTRU can match that of the controlling user or a local password, and can be the same or different from a local password used for other purposes.

According to a further embodiment of the invention, the responsive WTRU functions as a “tag” that has the express purpose of tracking or locating whatever it is connected to. In one embodiment, the tag WTRU is designed to be very small and consume a low amount of power. When there are no active connections but the power is on, most cellular devices go into a sleep mode and periodically wake up to look for paging messages. To conserve power, it may be opportune to provide a long on/off cycle that effectively disconnects the WTRU from the network each time it goes to sleep. With this type of operation, it could receive messages, but sacrifices the ability to be paged and reply to incoming calls. By limiting the function of such tag WTRUs, it is possible to operate them on a network without consuming substantial network resources.

The operation of the tag system is as follows:
1) Tag WTRU turns on.
2) Tag WTRU affiliates with the network.
3) Tag WTRU checks for incoming messages.
4) Tag WTRU does any processing directed by the messages.
5) Tag WTRU extracts location information, makes measurements, and sends messages.

The terminal at the controlling site can then interact with the tag WTRU.

By appropriately configuring the parameters in a message to the tag WTRU, battery life can be extended (less frequent activity), or more accurate or more timely data can be collected (more frequent activity). If no messages are received, outgoing messages can be sent to turn up the transmit power at the tag WTRU.

According to a further aspect of the invention, terminal locator devices provide more precise location. The techniques above do not provide very precise location functionality, and do not necessarily replace more precise location services for cellular systems. Nevertheless, there may be a desire to provide general locational data concerning a WTRU when other precise location features are unavailable. One possibility is to use a special device that also runs special application software. If the WTRU or the person or device to which it is attached needs to be precisely located, the terminal locator device provides supplemental location data.

One particular advantage of the supplemental location data is that it is not always possible to secure the location data provided by some network locating systems. For example, GPS data is difficult to acquire because most enclosed areas behave as Faraday enclosures for GPS signals.

The terminal locator device would have the capabilities of a WTRU used as a terminal, or alternatively it could be a peripheral device that attaches to a WTRU. In one configuration, the terminal locator device is able to receive and “direction find” or locate another WTRU that is transmitting signals intended for a base station. A cooperating WTRU at the remote site could send its physical channel parameters (such as, for example, frequency, timeslot, time offset, scrambling code, channelization codes) to the terminal locator device either directly, via the wireless network, via a separate device on the network, or through the controlling site. The terminal locator device then uses this information to perform a direction finding function.

A more elaborate implementation uses multiple cooperating terminal locator devices to establish a wider baseline for more accurate location. This is similar to device locators such as those used in the LoJack vehicle locator system, except that the terminal locator devices use network communications such as a cellular network. This works as follows:
1) The controlling site decides that the WTRU (or tag WTRU) at the controlled site is lost or needs to be located.
2) The controlling site sends a message to the controlled site to send its physical channel parameters.
3) The controlled WTRU enters a mode where transmissions occur on a regular basis, sufficient for the location to be successful—that is, for example the controlled WTRU requests a continuous dedicated connection to the network.
4) The controlled WTRU sends a message that includes the physical channel parameters of the dedicated connection. The message can be sent directly to the terminal locator devices or via the controlling site.
5) The controlling site sends the terminal locator devices coarse location information. Alternatively, the controlled WTRU can send messages directly to the terminal locator device.
6) The terminal locator devices then use the coarse information and the physical channel parameters to locate the controlled WTRU.
7) If the WTRU's physical channels are reconfigured, additional messages would need to be sent.

Alternatively, the controlled WTRU can decide for itself that it is lost, or the controlled WTRU can send an alarm triggered by someone pressing a “panic button.”

In a further embodiment, such remote commands can be used for diverse remote command functions, including using the home terminal or controlling terminal in turn to perform functions, such as control of the house lights, appliances, air conditioning.

Although the features and elements of the present invention are described in the preferred embodiments in particular combinations, each feature or element can be used alone (without the other features and elements of the preferred embodiments) or in various combinations with or without other features and elements of the present invention.

1. A method of controlling a wireless transmit/receive unit (WTRU), comprising:
establishing a communications protocol for controlling the WTRU through a wireless network connection;
providing a user control interface at a control location separate from the WTRU;
establishing a wireless network connection on a multiuser network; and
providing control communication between the WTRU and the control location through the wireless network connection.

2. The method of claim 1, wherein the control communication includes geographical location of the WTRU remotely provided to the user control interface.

3. The method of claim 2, further comprising using locating receivers receiving signals from the WTRU, thereby providing additional geographical location data to the user control interface.

4. The method of claim 2, further comprising using the geographical location of the WTRU to provide notification of a change in location through the user control interface.

5. The method of claim 1, wherein the control communication includes user interface control of the WTRU remotely provided to the WTRU through user control functions of the WTRU.

6. The method of claim 1, wherein the control communication includes access control data based on user control functions of the WTRU.

7. The method of claim 1, wherein the control communication includes user interface control of the WTRU and acknowledgement by the WTRU of the control functions.

8. The method of claim 1, further comprising:
obtaining data concerning network locations; and
combining the data concerning network locations with the control communication between the WTRU and the control location separate from the WTRU.

9. The method of claim 1, wherein the user interface uses said control communication to approximately track the movement of the WTRU.

10. The method of claim 1, wherein the user interface uses said control communication to provide an alarm if the WTRU moves out of a designated area.

11. The method of claim 1, wherein the user interface uses said control communication to provide an alarm in the case of periodic messages not received from the WTRU.

12. The method of claim 1, wherein the user interface uses said control communication to send messages to configure the parameters or processes on the WTRU.

13. The method of claim 1, wherein the WTRU provides functions of tracking or locating an item carrying the WTRU.

14. The method of claim 1, wherein:
the WTRU provides functions of tracking or locating an item carrying the WTRU; and
the WTRU executing a sleep mode extended to provide limited functionality of the WTRU, yet permit tracking functions.

15. The method of claim 1, wherein the WTRU executing a sleep mode extended to provide limited functionality of the WTRU, yet permit tracking functions, in which:
the WTRU turns on
the WTRU affiliates with the network by said establishing a wireless network connection;
the WTRU checks for incoming messages; and
the WTRU executes processing directed by the messages.

16. The method of claim 1, wherein the WTRU executing a sleep mode extended to provide limited functionality of the WTRU, yet permit tracking functions, in which:
the WTRU turns on
the WTRU affiliates with the network by said establishing a wireless network connection;
the WTRU checks for incoming messages;
the WTRU executes processing directed by the messages; and
the WTRU extracts location information, makes measurements, and sends messages to the user interface.

17. A wireless transmit/receive unit (WTRU) capable of receiving external controls, the WTRU comprising:
circuitry for accepting a wireless network connection on a multiuser network;
circuitry for accepting a communication link for controlling the WTRU through a wireless network connection using the wireless network connection to the WTRU; and
circuitry for providing control communication between the WTRU and the control location through the wireless network connection, whereby a user may use a user control interface at a control location separate from the WTRU to communicate with the WTRU.

18. The WTRU of claim 17, wherein the control communication includes geographical location of the WTRU remotely provided to the user control interface.

19. The WTRU of claim 17, wherein the control communication includes user interface control of the WTRU remotely provided to the WTRU through user control functions of the WTRU.

20. The WTRU of claim 17, wherein the control communication includes access control data based on user control functions of the WTRU.

21. The WTRU of claim 17, wherein the user interface uses said control communication to approximately track the movement of the WTRU.

22. The WTRU of claim 17, wherein the user interface uses said control communication to send messages to configure the parameters or processes on the WTRU.

23. The WTRU of claim 17, wherein:
the WTRU provides functions of tracking or locating an item carrying the WTRU; and
the WTRU executing a sleep mode extended to provide limited functionality of the WTRU, yet permit tracking functions.

24. The WTRU of claim 17, wherein the WTRU executing a sleep mode extended to provide limited functionality of the WTRU, yet permit tracking functions, in which:
the WTRU turns on
the WTRU affiliates with the network by said establishing a wireless network connection;
the WTRU checks for incoming messages; and
the WTRU executes processing directed by the messages.

25. The WTRU of claim 17, wherein the WTRU executing a sleep mode extended to provide limited functionality of the WTRU, yet permit tracking functions, in which:
the WTRU turns on
the WTRU affiliates with the network by said establishing a wireless network connection;
the WTRU checks for incoming messages;
the WTRU executes processing directed by the messages; and
the WTRU extracts location information, makes measurements, and sends messages to the user interface.

26. A method for tracking a subject object or person by use of a wireless network, the method comprising:
providing a wireless transmit/receive unit (WTRU) as a tracked object;
establishing a communications protocol for controlling the WTRU through a wireless network connection;
establishing a wireless network connection on a multiuser network;
providing communication between the WTRU and a tracking terminal through the wireless network connection; and
providing information concerning a status of the WTRU to the tracking terminal through said communication between the WTRU and the tracking terminal.

27. The method of claim 26., wherein the status communicated to the tracking terminal includes geographical location of the WTRU.

28. The method of claim 27, further comprising using locating receivers receiving signals from the WTRU, thereby providing additional geographical location data to the user control interface.

29. The method of claim 27, further comprising using the geographical location of the WTRU to provide notification of a change in location.

30. The method of claim 26, wherein the communication between the WTRU and the tracking terminal includes user interface control of the WTRU remotely provided to the WTRU through user control functions of the WTRU.

31. The method of claim 26, wherein the communication between the WTRU and the tracking terminal includes access control data based on user control functions of the WTRU.

32. The method of claim 26, wherein the tracking terminal uses said communication between the WTRU and a tracking terminal to provide an alarm if the WTRU moves out of a designated area.

33. The method of claim 26, wherein the tracking terminal uses said communication between the WTRU and the tracking terminal to provide an alarm in the case of periodic messages not received from the WTRU.

34. The method of claim 26, wherein the tracking terminal uses said communication between the WTRU and the tracking terminal to send messages to configure the parameters or processes on the WTRU.

35. The method of claim 26, wherein:
the WTRU provides functions of tracking or locating an item carrying the WTRU; and
the WTRU executing a sleep mode extended to provide limited functionality of the WTRU, yet permits tracking functions.

36. The method of claim 26, wherein the WTRU executing a sleep mode extended to provide limited functionality of the WTRU, yet permit tracking functions, in which:
the WTRU turns on
the WTRU affiliates with the network by said establishing a wireless network connection;
the WTRU checks for incoming messages; and
the WTRU executes processing directed by the messages.

37. The method of claim 26, wherein the WTRU executing a sleep mode extended to provide limited functionality of the WTRU, yet permits tracking functions, in which:
the WTRU turns on
the WTRU affiliates with the network by said establishing a wireless network connection;
the WTRU checks for incoming messages;
the WTRU executes processing directed by the messages; and
the WTRU extracts location information, makes measurements, and sends messages to the tracking terminal.

38. A semiconductor integrated circuit (IC) chip for use in a wireless transmit/receive unit (WTRU), the IC comprising:
circuitry for accepting a wireless network connection on a multiuser network;
circuitry for accepting a communication link from for controlling the WTRU through a wireless network connection using the wireless network connection to the WTRU; and
circuitry, responsive to program commands, for providing control communication between the WTRU and the control location through the wireless network connection of the WTRU, whereby a user may use a user control interface at a control location separate from the WTRU to communicate with the WTRU, thereby providing external control for the WTRU.

39. The IC of claim 38, wherein the program commands include program commands provided as embedded software in the WTRU.

40. The IC of claim 38, wherein the user interface uses said control communication to approximately track the movement of the WTRU.

41. The IC of claim 38, wherein:
the IC provides functions of tracking or locating an item carrying the WTRU; and
the IC executing a sleep mode extended to provide limited functionality of the WTRU, yet permit tracking functions.
